(19) United States
(12) Patent Application Publication
(10) Pub. No.: US 2024/0343895 A1
(43) Pub. Date: Oct. 17, 2024

(54) COLORABLE POLYMERIC COMPOSITIONS EXHIBITING ENHANCED AGING PROPERTIES

(71) Applicant: Dow Global Technologies LLC, Midland, MI (US)

(72) Inventors: Wenke Miao, Shanghai (CN); Mohamed Esseghir, Lawrenceville, NJ (US); Xianmin Xu, Shanghai (CN); Hong Yang, Shanghai (CN)

(21) Appl. No.: 18/253,451

(22) PCT Filed: Feb. 24, 2021
(86) PCT No.: PCT/CN2021/077702

§ 371 Date: May 18, 2023

(51) Int. Cl. C08L 23/08; C08K 5/134; C08K 5/3475; C08K 5/3492; H01B 3/44

(52) U.S. Cl. CPC C08L 23/08; C08K 5/134; C08K 5/3475; C08K 5/3492; H01B 3/441; C08K 2201/019; C08L 2203/202; C08L 2205/025; C08L 2207/062; C08L 2207/066

(57) ABSTRACT

A polymeric composition includes a first ethylene-based polymer having a density of 0.941 g/cc to 0.970 g/cc as measured according to ASTM D792, a second ethylene-based polymer has a density of 0.860 g/cc to 0.930 g/cc as measured according to ASTM D792, and an additive selected from the group consisting of an antioxidant, a hindered amine light stabilizer and combinations thereof. The polymeric composition has a Total Comonomer Content of 2.9 wt % or greater based on a total weight of the polymeric composition.

### BACKGROUND

### Field of the Invention

The present disclosure generally relates to polymeric compositions and more specifically to colorable polymeric compositions exhibiting enhanced aging properties.

### INTRODUCTION

Polymeric compositions are used for the formation of jacketing as an outermost layer on power and telecommunication cables. The jacketing helps to protect against physical damage the cable may endure during installation and/or use. Jacketing may be colored to help visually distinguish one cable from another. Cables have service lives of many years and undergo a variety of conditions during use. As such, the polymeric compositions forming the jacketing must meet certain mechanical properties after being subject to accelerated aging to ensure proper service life. For example, jacketing is often subjected to accelerated ultraviolet (“UV”) light aging as well as accelerated heat-aging to replicate weathering and extended service life. A polymeric composition that exhibits a 75% retained tensile elongation at break and 600% tensile elongation at break after 2000 hours of accelerated UV light aging (i.e., a “UV-Aged” state) is likely to pass the more stringent standards set ASTM D1248-16 and IEC 60811-401-2017 that apply to cable jacketing. Similarly, a polymeric composition that exhibits a 75% retained tensile elongation at break and 600% tensile elongation at break after 240 hours at 100° C. (i.e., a “Heat-Aged” state) will pass industrial standard GB/T2951.12-2008 for heat aging.

Free radicals and acids are generated within the polymeric composition during exposure to UV light and environmental conditions. The free radicals oxidize chains of the polymeric composition leading to decreased mechanical properties of the jacketing with increased UV exposure. Oxidation of the chains also forms acids within the jacketing. A conventional approach to mitigate the effect of free radicals in outdoor or high UV light exposure environments is to include both carbon black and hindered amine light stabilizers (“HALS”). Carbon black, while effective in absorbing ultraviolet light and preventing free radical generation, has a strong negative effect on the ability to impart a desired color to the jacketing. In addition to carbon black, HALS are utilized in the polymeric jacketing to neutralize free radicals that are generated. HALS are effective in neutralizing free radicals, but are deactivated by acids present in the environment of the polymer jacketing. As such, attempts at creating colorable cables through the exclusive use of HALS results in accelerated mechanical property degradation due to the greater production of free radicals and the deactivation of the HALS via the acids.

As explained above, polymeric compositions used for jacketing are exposed to accelerated heat aging in addition to accelerated ultraviolet aging. Traditional approaches of increasing the heat aging performance of a polymeric composition include the use of anti-oxidants, such as phenolic anti-oxidants and heat stabilizers. However, designing high density polyethylene compositions (i.e., compositions having a density of 0.930 g/cc or greater) with good heat aging continues to pose a challenge.

In view of the foregoing, it would be unexpected to discover a polymeric composition that can form a jacketing that is both colorable and is able to exhibit 75% retained tensile elongation at break and 600% tensile elongation at break after 2000 hours of accelerated UV light aging or 240 hours of heat aging at 100° C.

### SUMMARY OF THE DISCLOSURE

The present invention offers a polymeric composition useful as a cable jacketing that is both colorable and is able to exhibit 75% retained tensile elongation at break and 600% tensile elongation at break after 2000 hours of accelerated UV light aging or 240 hours of heat aging at 100° C.

The present invention is a result of discovering that using a blend of polymers that results in the polymeric composition having a Total Comonomer Content of 2.9 wt % or greater, the polymeric composition can exhibit the above-noted properties. It has been surprisingly discovered that the Total Comonomer Content of the polymeric composition affects the retained tensile elongation at break and tensile strength after accelerated UV aging. Such a result is surprising as it represents a heretofore unrecognized parameter that affects the UV resistance of a polymeric composition independent of conventional UV resistance additives. Also surprisingly discovered is that the Total Comonomer Content affects the retained tensile elongation at break and tensile strength after accelerated heat aging. Such a result is surprising as increased comonomer content is associated with decreased crystallinity and density; the opposite approach conventionally used to increase heat aging performance in polymeric compositions.

The present invention is particularly useful for cable jackets.

According to a first feature of the present disclosure, a polymeric composition, comprises a first ethylene-based polymer having a density of 0.941 g/cc to 0.970 g/cc as measured according to ASTM D792; a second ethylene-based polymer having a density of 0.860 g/cc to 0.930 g/cc as measured according to ASTM D792; and an additive selected from the group consisting of an antioxidant, a hindered amine light stabilizer and combinations thereof, wherein polymeric composition has a Total Comonomer Content of 2.9 wt % or greater based on a total weight of the polymeric composition.

According to a second feature of the present disclosure, the polymeric composition comprises 40 wt % to 95 wt % of the first ethylene-based polymer based on the total weight of the polymeric composition.

According to a third feature of the present disclosure, the polymeric composition comprises 5 wt % to 60 wt % of the second ethylene-based polymer based on the total weight of the polymeric composition.

According to a fourth feature of the present disclosure, the polymeric composition is free of carbon black.

According to a fifth feature of the present disclosure, the polymeric composition has a density of 0.945 g/cc or less as measured according to ASTM D792.

According to a sixth feature of the present disclosure, the polymeric composition exhibits a tensile elongation at break of 600% or greater in a UV-Aged state as measured according to ASTM D638.

According to a seventh feature of the present disclosure, the polymeric composition has a density of 0.930 g/cc to 0.945 g/cc as measured according to ASTM D792.

According to an eighth feature of the present disclosure, a density of the second ethylene-based polymer is from 0.918 g/cc to 0.930 g/cc as measured according to ASTM D792.

According to a ninth feature of the present disclosure, the polymeric composition exhibits a tensile elongation at break of 600% or greater as measured according to ASTM D638 after aging for 240 hours at 100° C.

According to a tenth feature of the present disclosure, a coated conductor comprises a conductor and the polymeric composition disposed around the conductor.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); IEC refers to International Electrotechnical Commission; EN refers to European Norm; DIN refers to Deutsches Institut für Normung; and ISO refers to International Organization for Standards.

As used herein, the term weight percent (“wt %”) designates the percentage by weight a component is of a total weight of the polymeric composition unless otherwise specified.

Melt index (I₂) values herein refer to values determined according to ASTM method D1238 at 190 degrees Celsius (° C.) with 2.16 Kilogram (Kg) mass and are provided in units of grams eluted per ten minutes (“g/10 min”).

Density values herein refer to values determined according to ASTM D792 at 23° C. and are provided in units of grams per cubic centimeter (“g/cc”).

As used herein, Chemical Abstract Services registration numbers (“CAS #”) refer to the unique numeric identifier as most recently assigned as of the priority date of this document to a chemical compound by the Chemical Abstracts Service.

### Polymeric Composition

The polymeric composition of the present invention comprises a first ethylene-based polymer, a second ethylene-based polymer and an additive selected from the group consisting of an antioxidant, a hindered amine light stabilizer and combinations thereof.

### First Ethylene-Based Polymer

As noted above, one component of the polymeric composition is the first ethylene-based polymer. As used herein, “ethylene-based” polymers are polymers in which greater than 40 wt % of the monomers are ethylene though other co-monomers may also be employed. “Polymer” means a macromolecular compound comprising a plurality of monomers of the same or different type which are bonded together, and includes homopolymers and interpolymers. “Interpolymer” means a polymer comprising at least two different monomer types bonded together. Interpolymer includes copolymers (usually employed to refer to polymers prepared from two different monomer types), and polymers prepared from more than two different monomer types (e.g., terpolymers (three different monomer types) and quaterpolymers (four different monomer types)). The ethylene-based polymer can be an ethylene homopolymer. As used herein, “homopolymer” denotes a polymer comprising repeating units derived from a single monomer type, but does not exclude residual amounts of other components used in preparing the homopolymer, such as catalysts, initiators, solvents, and chain transfer agents.

The ethylene-based polymer can have a unimodal or a multimodal molecular weight distribution and can be used alone or in combination with one or more other types of ethylene-based polymers (e.g., a blend of two or more ethylene-based polymers that differ from one another by monomer composition and content, catalytic method of preparation, molecular weight, molecular weight distributions, densities, etc.). If a blend of ethylene-based polymers is employed, the polymers can be blended by any in-reactor or post-reactor process.

The ethylene-based polymer may comprise 40 mol % or greater, or 45 mol % or greater, or 50 mol % or greater, or 60 mol % or greater, or 70 mol % or greater, or 80 mol % or greater, or 85 mol % or greater, or 90 mol % or greater, or 91 mol % or greater, or 92 mol % or greater, or 93 mol % or greater, or 94 mol % or greater, or 95 mol % or greater, or 96 mol % or greater, or 97 mol % or greater, or 97.5 mol % or greater, or 98 mol % or greater, or 99 mol % or greater, while at the same time, 100 mol % or less, or 99.5 mol % or less, or 99 mol % or less, or 98 mol % or less, or 97 mol % or less, or 96 mol % or less, or 95 mol % or less, or 94 mol % or less, or 93 mol % or less, or 92 mol % or less, or 91 mol % or less, or 90 mol % or less, or 85 mol % or less, or 80 mol % or less, or 70 mol % or less, or 60 mol % or less, or 50 mol % or less, or 45 mol % or less of ethylene as measured using C13 Nuclear Magnetic Resonance (“NMR”) as explained in greater detail below. Other units, or comonomers, of the ethylene-based polymer may include C₃, or C₄, or C₆, or C₈, or C₁₀, or C₁₂, or C₁₆, or C₁₈, or C₂₀ α-olefins, such as propylene, 1-butene, 1-hexene, 4-methyl-1-pentene, and 1-octene.

The comonomer content of the first ethylene-based polymer may be 0 wt % or greater, or 0.5 wt % or greater, or 1.0 wt % or greater, or 1.5 wt % or greater, or 2.0 wt % or greater, or 2.5 wt % or greater, or 3.0 wt % or greater, or 3.5 wt % or greater, or 4.0 wt % or greater, or 4.5 wt % or greater, or 5.0 wt % or greater, or 5.5 wt % or greater, or 6.0 wt % or greater, or 6.5 wt % or greater, or 7.0 wt % or greater, or 7.5 wt % or greater, or 8.0 wt % or greater, or 8.5 wt % or greater, or 9.0 wt % or greater, or 9.5 wt % or greater, while at the same time, 10.0 wt % or less, or 9.5 wt % or less, or 9.0 wt % or less, or 8.5 wt % or less, or 8.0 wt % or less, or 7.5 wt % or less, or 7.0 wt % or less, or 6.5 wt % or less, or 6.0 wt % or less, or 5.5 wt % or less, or 5.0 wt % or less, or 4.5 wt % or less, or 4.0 wt % or less, or 3.5 wt % or less, or 3.0 wt % or less, or 2.5 wt % or less, or 2.0 wt % or less, or 1.5 wt % or less, or 1.0 wt % or less, or 0.5 wt % or less based on the total weight of the first ethylene-based polymer as measured according to NMR. The comonomer content is the total weight percent of all comonomers present in the first ethylene-based polymer based on the weight of the first ethylene-based polymer.

The polymeric composition of claim 1, wherein the polymeric composition comprises 40 wt % to 95 wt % of the first ethylene-based polymer based on the total weight of the polymeric composition. For example, the polymeric composition may comprise 40 wt % or greater, or 45 wt % or greater, or 50 wt % or greater, or 55 wt % or greater, or 60 wt % or greater, or 65 wt % or greater, or 70 wt % or greater, or 75 wt % or greater, or 80 wt % or greater, or 85 wt % or greater, or 90 wt % or greater, while at the same time, 95 wt % or less, or 90 wt % or less, or 85 wt % or less, or 80 wt % or less, or 75 wt % or less, or 70 wt % or less, or 65 wt % or less, or 60 wt % or less, or 55 wt % or less, or 50 wt % or less, or 45 wt % or less of the first ethylene-based polymer based on the total weight of the polymeric composition.

The first ethylene-based polymer may have a density of 0.941 g/cc to 0.970 g/cc as measured according to ASTM D792. For example, the first ethylene-based polymer may have a density of 0.941 g/cc or greater, or 0.945 g/cc or greater, or 0.950 g/cc or greater, or 0.955 g/cc or greater, or 0.960 g/cc or greater, or 0.965 g/cc or greater, while at the same time, 0.970 g/cc or less, or 0.965 g/cc or less, or 0.960 g/cc or less, or 0.955 g/cc or less, or 0.950 g/cc or less, or 0.945 g/cc or less as measured according to ASTM D792.

### Second Ethylene-Based Polymer

The polymeric composition also comprises the second ethylene-based polymer. The description of ethylene-based polymers provided in connection with the first ethylene-based polymer applies to the second ethylene-based polymer.

The polymeric composition comprises 5 wt % to 60 wt % of the second ethylene-based polymer based on the total weight of the polymeric composition. For example, the polymeric composition may comprise 5 wt % or greater, or 10 wt % or greater, or 15 wt % or greater, or 20 wt % or greater, or 25 wt % or greater, or 30 wt % or greater, or 35 wt % or greater, or 40 wt % or greater, or 45 wt % or greater, or 50 wt % or greater, or 55 wt % or greater, while at the same time, 60 wt % or less, or 55 wt % or less, or 50 wt % or less, or 45 wt % or less, or 40 wt % or less, or 35 wt % or less, or 30 wt % or less, or 25 wt % or less, or 20 wt % or less, or 15 wt % or less, or 10 wt % or less of the second ethylene-based polymer based on the total weight of the polymeric composition.

The second ethylene-based polymer may have a density of 0.860 g/cc to 0.930 g/cc as measured according to ASTM D792. For example, the first ethylene-based polymer may have a density of 0.860 g/cc or greater, or 0.865 g/cc or greater, or 0.870 g/cc or greater, or 0.875 g/cc or greater, or 0.880 g/cc or greater, or 0.885 g/cc or greater, or 0.890 g/cc or greater, or 0.895 g/cc or greater, or 0.900 g/cc or greater, or 0.905 g/cc or greater, or 0.910 g/cc or greater, or 0.915 g/cc or greater, or 0.918 g/cc or greater, or 0.920 g/cc or greater, or 0.922 g/cc or greater, or 0.924 g/cc or greater, or 0.926 g/cc or greater, or 0.928 g/cc or greater, while at the same time, 0.930 g/cc or less, or 0.928 g/cc or less, or 0.926 g/cc or less, or 0.924 g/cc or less, or 0.922 g/cc or less, or 0.920 g/cc or less, or 0.915 g/cc or less, or 0.910 g/cc or less, or 0.905 g/cc or less, or 0.900 g/cc or less, or 0.895 g/cc or less, or 0.890 g/cc or less, or 0.885 g/cc or less, or 0.880 g/cc or less, or 0.875 g/cc or less, or 0.870 g/cc or less, or 0.865 g/cc or less as measured according to ASTM D792.

The comonomer content of the second ethylene-based polymer may be 0 wt % or greater, or 0.5 wt % or greater, or 1.0 wt % or greater, or 1.5 wt % or greater, or 2.0 wt % or greater, or 2.5 wt % or greater, or 3.0 wt % or greater, or 3.5 wt % or greater, or 4.0 wt % or greater, or 4.5 wt % or greater, or 5.0 wt % or greater, or 5.5 wt % or greater, or 6.0 wt % or greater, or 6.5 wt % or greater, or 7.0 wt % or greater, or 7.5 wt % or greater, or 8.0 wt % or greater, or 8.5 wt % or greater, or 9.0 wt % or greater, or 9.5 wt % or greater, or 10.0 wt % or greater, or 10.5 wt % or greater, or 11.0 wt % or greater, or 11.5 wt % or greater, or 12.0 wt % or greater, or 12.5 wt % or greater, or 13.0 wt % or greater, or 13.5 wt % or greater, or 14.0 wt % or greater, or 14.5 wt % or greater, or 15.0 wt % or greater, or 15.5 wt % or greater, or 16.0 wt % or greater, or 16.5 wt % or greater, or 17.0 wt % or greater, or 17.5 wt % or greater, or 18.0 wt % or greater, or 18.5 wt % or greater, or 19.0 wt % or greater, or 19.5 wt % or greater, 20.0 wt % or greater, or 20.5 wt % or greater, or 21.0 wt % or greater, or 21.5 wt % or greater, or 22.0 wt % or greater, or 22.5 wt % or greater, or 23.0 wt % or greater, or 23.5 wt % or greater, or 24.0 wt % or greater, or 24.5 wt % or greater, or 25.0 wt % or greater, or 25.5 wt % or greater, or 26.0 wt % or greater, or 26.5 wt % or greater, or 27.0 wt % or greater, or 27.5 wt % or greater, or 28.0 wt % or greater, or 28.5 wt % or greater, or 29.0 wt % or greater, or 29.5 wt % or greater, or 30.0 wt % or greater, or 40.0 wt % or greater, or 50.0 wt % or greater, or 55.0 wt % or greater, while at the same time, 60.0 wt % or less, or 55.0 wt % or less, or 50.0 wt % or less, or 40.0 wt % or less, or 30.0 wt % or less, or 29.5 wt % or less, or 29.0 wt % or less, or 28.5 wt % or less, or 28.0 wt % or less, or 27.5 wt % or less, or 27.0 wt % or less, or 26.5 wt % or less, or 26.0 wt % or less, or 25.5 wt % or less, or 25.0 wt % or less, or 24.5 wt % or less, or 24.0 wt % or less, or 23.5 wt % or less, or 23.0 wt % or less, or 22.5 wt % or less, or 22.0 wt % or less, or 21.5 wt % or less, or 21.0 wt % or less, or 20.5 wt % or less, 20.0 wt % or less, or 19.5 wt % or less, or 19.0 wt % or less, or 18.5 wt % or less, or 18.0 wt % or less, or 17.5 wt % or less, or 17.0 wt % or less, or 16.5 wt % or less, or 16.0 wt % or less, or 15.5 wt % or less, or 15.0 wt % or less, or 14.5 wt % or less, or 14.0 wt % or less, or 13.5 wt % or less, or 13.0 wt % or less, or 12.5 wt % or less, or 12.0 wt % or less, or 11.5 wt % or less, or 11.0 wt % or less, or 10.5 wt % or less 10.0 wt % or less, or 9.5 wt % or less, or 9.0 wt % or less, or 8.5 wt % or less, or 8.0 wt % or less, or 7.5 wt % or less, or 7.0 wt % or less, or 6.5 wt % or less, or 6.0 wt % or less, or 5.5 wt % or less, or 5.0 wt % or less, or 4.5 wt % or less, or 4.0 wt % or less, or 3.5 wt % or less, or 3.0 wt % or less, or 2.5 wt % or less, or 2.0 wt % or less, or 1.5 wt % or less, or 1.0 wt % or less, or 0.5 wt % or less based on the total weight of the second ethylene-based polymer as measured according to NMR. The comonomer content is the total weight percent of all comonomers present in the second ethylene-based polymer based on the weight of the second ethylene-based polymer.

### Total Comonomer Content

As explained above, it has surprisingly been discovered that the polymeric composition's mechanical properties after UV-aging and heat-aging are dependent upon the Total Comonomer Content of the polymeric composition. Specifically, when the polymeric composition has a Total Comonomer Content of 2.9 wt % or greater based on a total weight of the polymeric composition the polymeric composition may achieve UV-aging and heat-aging standards. The Total Comonomer Content of the polymeric composition may be 2.9 wt % or greater, or 3.0 wt % or greater, or 3.2 wt % or greater, or 3.4 wt % or greater, or 3.6 wt % or greater, or 3.8 wt % or greater, or 4.0 wt % or greater, or 4.2 wt % or greater, or 4.4 wt % or greater, or 4.6 wt % or greater, or 4.8 wt % or greater, or 5.0 wt % or greater, or 5.2 wt % or greater, or 5.4 wt % or greater, or 5.6 wt % or greater, or 5.8 wt % or greater, or 6.0 wt % or greater, or 7.0 wt % or greater, or 8.0 wt % or greater, or 9.0 wt % or greater, or 10.0 wt % or greater based on the total weight of the polymeric composition. The NMR method of measuring the Total Comonomer Content is provided in the examples section.

Additives The polymeric composition may comprise additional additives in the form of anti-oxidants, cross-linking co-agents, hindered amine light stabilizers (“HALS”), cure boosters and scorch retardants, processing aids, coupling agents, ultraviolet stabilizers (including UV absorbers), antistatic agents, additional nucleating agents, slip agents, lubricants, viscosity control agents, tackifiers, anti-blocking agents, surfactants, extender oils, acid scavengers, flame retardants and metal deactivators.

The polymeric composition may comprise from 0.01 wt % to 10 wt % of each additive. For example, the polymeric composition may comprise 0.1 wt % or greater, or 0.2 wt % or greater, or 0.3 wt % or greater, or 0.4 wt % or greater, or 0.5 wt % or greater, or 0.6 wt % or greater, or 0.7 wt % or greater, or 0.8 wt % or greater, or 0.9 wt % or greater, or 1.0 wt % or greater, or 2.0 wt % or greater, or 3.0 wt % or greater, or 4.0 wt % or greater, or 5.0 wt % or greater, or 6.0 wt % or greater, or 7.0 wt % or greater, or 8.0 wt % or greater, or 9.0 wt % or greater, while at the same time, 10.0 wt % or less, or 9.0 wt % or less, or 8.0 wt % or less, or 7.0 wt % or less, or 6.0 wt % or less, or 5.0 wt % or less, or 4.0 wt % or less, or 3.0 wt % or less, or 2.0 wt % or less, or 1.0 wt % or less, or 0.9 wt % or less, or 0.8 wt % or less, or 0.7 wt % or less, or 0.6 wt % or less, or 0.5 wt % or less, or 0.4 wt % or less, or 0.3 wt % or less, or 0.2 wt % or less of each of the additives.

HALS are chemical compounds containing an amine functional group that are used as stabilizers in plastics and polymers. These compounds may be derivatives of tetramethylpiperidine and are primarily used to protect the polymers from the effects of free radical oxidation due to exposure to UV light. The HALS may include one or more of poly (4-hydroxy-2,2,6,6-tetramethyl-1-piperidineethanol-alt-1,4-butanedioic acid) (CAS #65447-77-0); bis (2,2,6,6-tetramethyl-4-piperidyl) sebacate (CAS #52829 Jul. 9); di-(1,2,2,6,6-pentamethyl-4-piperidyl)-2-butyl-2-(3,5-di-tert-butyl-4-hydroxybenzyl) malonate (CAS #63843-89-0); bis (1-octyloxy-2,2,6,6-tetramethyl-4-piperidyl) sebacate (CAS #129757-67-1); poly [[6-[(1,1,3,3-tetramethylbutyl) amino]-s-triazine-2,4-diyl]-[(2,2,6,6-tetramethyl-4-piperidyl) imino]-hexamethylene-[(2,2,6,6-tetramethyl-4-piperidyl) imino](CAS #71878-19-8); 1,3,5-Triazine-2,4,6-triamine, N,N′″-1,2-ethanediylbis [N-[3-[[4,6-bis [butyl (1,2,2,6,6-pentamethyl-4-piperidinyl) amino]-1,3,5-triazin-2-yl]amino]propyl]-N′,N″-dibutyl-N′,N″-bis (1,2,2,6,6-pentamethyl-4-piperidinyl)-(CAS #106990-43-6); 1,6-Hexanediamine, N,N′-bis (2,2,6,6-tetramethyl-4-piperidinyl)-, polymer with 2,4,6-trichloro-1,3,5-triazine, reaction products with, N-butyl-1-butanamine and N-butyl-2,2,6,6-tetramethyl-4-piperidinamine (CAS #192268-64-7). Examples of the HALS are commercially available under the tradenames TINUVIN™ 622 and CHIMASSORB™ 944 from BASF, Ludwigshafen, Germany. Other UV stabilizers include, for example, UVASORB™ HA10 and HA88 (both commercially available from 3V Sigma USA), CHIMASSORB™ 944 LD (commercially available from BASF), and CYASORB® THT 4801, THT 7001, and THT 6460 (each commercially available from Solvay Corp.).

The polymeric composition may be free of carbon black. As used herein, the term “free of” is defined to mean that the formulation comprises less than 0.5 wt % of carbon black based on a total weight of the polymeric composition. As highlighted above, carbon black is effective in absorbing ultraviolet light and preventing free radical generation but has a strong effect on the ability to impart a desired color to the polymeric composition.

The polymeric composition may comprise a colorant. As explained above, the absence of carbon black allows the polymeric composition to be colorable by a colorant. The colorant may comprise one or more of an azo dye, an anthraquinone dye and phthalocyanines. The polymeric composition may comprise one or more COLOUR INDEX™ generic name colorants such as Pigment Violet 32 (CAS #12225-08-0), Pigment Orange 34 (CAS #15793-73-4), Pigment Red 38 (CAS #6358-87-8), Pigment Red 208 (CAS #31778 Oct. 6), Pigment Red 48:2 (CAS #7023-61-2), Pigment Red 57:1 (CAS #5281 Apr. 9), Pigment Yellow 155 (CAS #68516-73-4/77465-46-4), Pigment Yellow 151 (CAS #31837-42-0), Pigment Green 7 (CAS #1328-53-6), Pigment Red 122 (CAS #980-26-7/16043-40-6), Pigment Red 214 (CAS #40618-31-3), Pigment Violet 23 (CAS #6358-30-1), and/or Pigment Yellow 191 (CAS #129423-54-7).

The polymeric composition can include one or more particulate fillers, such as glass fibers or various mineral fillers including nano-composites. Fillers, especially those with elongated or platelet-shaped particles providing a higher aspect ratio (length/thickness), may improve modulus and post-extrusion shrinkage characteristics. The filler(s) can have a median size or d50 of less than 20 μm, less than 10 μm, or less than 5 μm. The fillers may be surface treated to facilitate wetting or dispersion in the polymeric composition. Specific examples of suitable fillers include, but are not limited to, titanium dioxide, zinc oxide, calcium carbonate, silica, quartz, fused quartz, talc, mica, clay, kaolin, wollastonite, feldspar, aluminum hydroxide, and graphite. Fillers may be included in the polymeric composition in an amount ranging from 2 to 30 wt %, or from 5 to 30 wt % based on the total weight of the polymeric composition.

The processing aids may comprise metal 1 salts of fluororesin such as polytetrafluoroethylene or Fluorinated ethylene propylene; carboxylic acids such as zinc stearate or calcium stearate; fatty acids such as stearic acid, oleic acid, or erucic acid; fatty amides such as stearamide, oleamide, erucamide, or N,N′-ethylene bis-stearamide; polyethylene wax; oxidized polyethylene wax; polymers of ethylene oxide; copolymers of ethylene oxide and propylene oxide; vegetable waxes; petroleum waxes; non-ionic surfactants; silicone fluids and polysiloxanes.

The antioxidants may comprise hindered phenols such as tetrakis [methylene (3,5-di-tert-butyl-4-hydroxyhydro-cinnamate)]methane; bis [(beta-(3,5-ditert-butyl-4-hydroxybenzyl) methylcarboxyethyl)]-sulphide, 4,4′-thiobis (2-methyl-6-tert-butylphenol), 4,4′-thiobis (2-tert-butyl-5-methylphenol), 2,2′-thiobis (4-methyl-6-tert-butylphenol), and thiodiethylene bis (3,5-di-tert-butyl-4-hydroxy)-hydrocinnamate; phosphites and phosphonites such as tris (2,4-di-tert-butylphenyl) phosphite and di-tert-butylphenyl-phosphonite; thio compounds such as dilaurylthiodipropionate, dimyristylthiodipropionate, and distearylthiodipropionate; various siloxanes; polymerized 2,2,4-trimethyl-1,2-dihydroquinoline, n,n′-bis (1,4-dimethylpentyl-p-phenylenediamine), alkylated diphenylamines, 4,4′-bis (alpha, alpha-dimethylbenzyl) diphenylamine, diphenyl-p-phenylenediamine, mixed di-aryl-p-phenylenediamines, and other hindered amine anti-degradants or stabilizers.

### Compounding

The components of the polymeric composition can be added to a batch or continuous mixer for melt blending. The components can be added in any order or first preparing one or more masterbatches for blending with the other components. The melt blending may be conducted at a temperature above the highest melting polymer. The melt-blended composition can then either be delivered to an extruder or an injection-molding machine or passed through a die for shaping into the desired article, or converted to pellets, tape, strip or film or some other form for storage or to prepare the material for feeding to a next shaping or processing step. Optionally, if shaped into pellets or some similar configuration, then the pellets, etc. can be coated with an anti-block agent to facilitate handling while in storage.

Examples of compounding equipment that may be used include internal batch mixers, continuous single or twin-screw mixers, or kneading continuous extruders. The type of mixer utilized, and the operating conditions of the mixer, will affect properties of the composition such as viscosity, volume resistivity, and extruded surface smoothness.

### Mechanical Properties

The polymeric composition may exhibit an Unaged (i.e., a state with no aging performed), UV-Aged and/or Heat-Aged maximum tensile strength of 20.0 megapascals (MPa) to 45.0 MPa as measured according to ASTM D638. For example the polymeric composition may exhibit a maximum tensile strength of 20.0 MPa or greater, or 20.5 MPa or greater, or 21.0 MPa or greater, or 21.5 MPa or greater, or 22.0 MPa or greater, or 22.5 MPa or greater, or 23.0 MPa or greater, or 23.5 MPa or greater, or 24.0 MPa or greater, or 24.5 MPa or greater, or 25.0 MPa or greater, or 25.5 MPa or greater, or 26.0 MPa or greater, or 26.5 MPa or greater, or 27.0 MPa or greater, or 27.5 MPa or greater, or 28.0 MPa or greater, or 28.5 MPa or greater, or 29.0 MPa or greater, or 29.5 MPa or greater, or 30.0 MPa or greater, or 30.5 MPa or greater, or 31.0 MPa or greater, or 31.5 MPa or greater, or 32.0 MPa or greater, or 32.5 MPa or greater, or 33.0 MPa or greater, or 33.5 MPa or greater, or 34.0 MPa or greater, or 34.5 MPa or greater, or 35.0 MPa or greater, or 35.5 MPa or greater, or 36.0 MPa or greater, or 36.5 MPa or greater, or 37.0 MPa or greater, or 37.5 MPa or greater, or 38.0 MPa or greater, or 38.5 MPa or greater, or 39.0 MPa or greater, or 39.5 MPa or greater, or 40.0 MPa or greater, or 40.5 MPa or greater, or 41.0 MPa or greater, or 41.5 MPa or greater, or 42.0 MPa or greater, or 42.5 MPa or greater, or 43.0 MPa or greater, or 43.5 MPa or greater, or 44.0 MPa or greater, or 44.5 MPa or greater, while at the same time, 45.0 MPa or less, or 44.5 MPa or less, or 44.0 MPa or less, or 43.5 MPa or less, or 43.0 MPa or less, or 42.5 MPa or less, or 42.0 MPa or less, or 41.5 MPa or less, or 41.0 MPa or less, or 40.5 MPa or less, or 40.0 MPa or less, or 39.5 MPa or less, or 39.0 MPa or less, or 38.5 MPa or less, or 38.0 MPa or less, or 37.5 MPa or less, or 37.0 MPa or less, or 36.5 MPa or less, or 36.0 MPa or less, or 35.5 MPa or less, or 35.0 MPa or less, or 34.5 MPa or less, or 34.0 MPa or less, or 33.5 MPa or less, or 33.0 MPa or less, or 32.5 MPa or less, or 32.0 MPa or less, or 31.5 MPa or less, or 31.0 MPa or less, or 30.5 MPa or less, or 30.0 MPa or less, or 29.5 MPa or less, or 29.0 MPa or less, or 28.5 MPa or less, or 28.0 MPa or less, or 27.5 MPa or less, or 27.0 MPa or less, or 26.5 MPa or less, or 26.0 MPa or less, or 25.5 MPa or less, or 25.0 MPa or less, or 24.5 MPa or less, or 24.0 MPa or less, or 23.5 MPa or less, or 23.0 MPa or less, or 22.5 MPa or less, or 22.0 MPa or less, or 21.5 MPa or less, or 21.0 MPa or less, or 20.5 MPa or less.

The polymeric composition may exhibit an Unaged, UV-Aged or Heat-Aged elongation at break of 600% to 1200% as measured according to ASTM D638. For example the polymeric composition may exhibit an elongation at break of 600% or greater, or 610% or greater, or 620% or greater, or 630% or greater, or 640% or greater, or 650% or greater, or 660% or greater, or 670% or greater, or 680% or greater, or 690% or greater, or 700% or greater, or 710% or greater, or 720% or greater, or 730% or greater, or 740% or greater, or 750% or greater, or 760% or greater, or 770% or greater, or 780% or greater, or 790% or greater, or 800% or greater, or 810% or greater, or 820% or greater, or 830% or greater, or 840% or greater, or 850% or greater, or 860% or greater, or 870% or greater, or 880% or greater, or 890% or greater, or 900% or greater, or 910% or greater, or 920% or greater, or 930% or greater, or 940% or greater, or 950% or greater, or 960% or greater, or 970% or greater, or 980% or greater, or 990% or greater, or 1000% or greater, or 1010% or greater, or 1020% or greater, or 1030% or greater, or 1040% or greater, or 1050% or greater, or 1060% or greater, or 1070% or greater, or 1080% or greater, or 1090% or greater, or 1100% or greater, or 1110% or greater, or 1120% or greater, or 1130% or greater, or 1140% or greater, or 1150% or greater, or 1160% or greater, or 1170% or greater, or 1180% or greater, or 1190% or greater, while at the same time, 1200% or less, or 1190% or less, or 1180% or less, or 1170% or less, or 1160% or less, or 1150% or less, or 1140% or less, or 1130% or less, or 1120% or less, or 1110% or less, or 1100% or less, or 1090% or less, or 1080% or less, or 1070% or less, or 1060% or less, or 1050% or less, or 1040% or less, or 1030% or less, or 1020% or less, or 1010% or less, or 1000% or less, or 990% or less, or 980% or less, or 970% or less, or 960% or less, or 950% or less, or 940% or less, or 930% or less, or 920% or less, or 910% or less, or 900% or less, or 890% or less, or 880% or less, or 870% or less, or 860% or less, or 850% or less, or 840% or less, or 830% or less, or 820% or less, or 810% or less, or 800% or less, or 790% or less, or 780% or less, or 770% or less, or 760% or less, or 750% or less, or 740% or less, or 730% or less, or 720% or less, or 710% or less, or 700% or less, or 690% or less, or 680% or less, or 670% or less, or 660% or less, or 650% or less, or 640% or less, or 630% or less, or 620% or less, or 610% or less.

The polymeric composition may have a retained maximum tensile strength and/or a retained elongation at break (both measured by dividing the UV-Aged or Heat-Aged value by the Unaged value) of 65% or greater, or 70% or greater, or 75% or greater, or 80% or greater, or 85% or greater, or 90% or greater, or 95% or greater, or 100% or greater, or 105% or greater, or 110% or greater, or 115% or greater, while at the same time, or 120% or less, or 115% or less, or 110% or less, or 105% or less, or 100% or less, or 95% or less, or 90% or less, or 85% or less, or 80% or less, or 75% or less, or 70% or less.

### Coated Conductor

The present disclosure also provides a coated conductor. The coated conductor includes a conductor and a coating on the conductor, the coating including the polymeric composition. The polymeric composition is at least partially disposed around the conductor to produce the coated conductor. The conductor may comprise a conductive metal or an optically transparent structure.

The process for producing a coated conductor includes mixing and heating the polymeric composition to at least the melting temperature of the polymeric components in an extruder to form a polymeric melt blend, and then coating the polymeric melt blend onto the conductor. The term “onto” includes direct contact or indirect contact between the polymeric melt blend and the conductor. The polymeric melt blend is in an extrudable state.

The polymeric composition is disposed on and/or around the conductor to form a coating. The coating may be one or more inner layers such as an insulating layer. The coating may wholly or partially cover or otherwise surround or encase the conductor. The coating may be the sole component surrounding the conductor. Alternatively, the coating may be one layer of a multilayer jacket or sheath encasing the conductor. The coating may directly contact the conductor. The coating may directly contact an insulation layer surrounding the conductor.

### EXAMPLES

### Materials

The following materials are employed in the Examples, below.

HDPE1 is an ethylene/hexene copolymer having a density of 0.946 g/cc, a melt index of 0.95 g/10 min. and a hexene comonomer content 2.28 wt % based on the weight of the HDPE1 as measured according to NMR. HDPE1 is available from The Dow Chemical Company, Midland, MI

LLDPE1 is a linear low-density polyethylene having density of 0.926 g/cc and a melt index of 0.93 g/10 min. and having a butene comonomer content of 7.5 wt % as measured according to NMR. LLDPE 1 is available from The Dow Chemical Company, Midland, MI.

HDPE2 is an ethylene homopolymer having a density of 0.961 g/cc and a melt index of 0.80 g/10 min. and is available from The Dow Chemical Company, Midland, MI.

LLDPE2 is a linear low-density polyethylene having a density of 0.919 g/cc, a melt index of 0.90 g/10 min. and a hexene comonomer content of 8.27 wt % based on the total weight of LLDPE2 as measured according to NMR. LLDPE2 is available from The Dow Chemical Company, Midland, MI.

AO is a sterically hindered phenolic antioxidant having the chemical name pentaerythritol tetrakis (3-(3,5-di-tert-butyl-4-hydroxyphenyl) propionate), and is commercially available as IRGANOX 1010™ from BASF, Ludwigshafen, Germany.

UVA is an ultraviolet light absorber with the chemical composition 2-tert-Butyl-6-(5-chloro-2H-benzotriazol-2-yl)-4-methylphenol (CAS number 3896 Nov. 5) and commercially available as TINUVIN™ 326 from BASF, Ludwigshafen, Germany.

HALS is a 50 wt % mixture of Poly [[6- [(1, 1,3,3-tetramethylbutyl) amino]-s-triazine-2,4-diyl]-[(2,2,6,6-tetramethyl-4-piperidyl) imino]-hexamethylene-[(2,2,6,6-tetramethyl-4-piperidyl) imino](CAS number 71878-19-8) and 50 wt % Poly (4-hydroxy-2,2,6,6-tetramethyl-1-piperidine ethanol-alt-1,4-butanedioic acid) (CAS number 65447-77-0) and is commercially available as TINUVIN™ 783 from BASF, Ludwigshafen, Germany.

PA is a fluororesin processing aid commercially available under the tradename DYNAMAR™ FX 5912 available from 3M, Saint Paul, Minnesota, USA.

### Sample Preparation

Samples were prepared by compounding the HDPE and the LLDPE in a BRABENDER™ mixer at 150° C. The rotor speed of the mixer was set to 30 revolutions per minute (“RPM”). The components other than the HDPE and LDPE were fed into the mixer. The rotor speed was increased to 80 RPM and the samples were mixed for an additional 5 minutes. The samples were then cooled and cut into small pieces.

Forty grams of the small pieces were sandwiched between two biaxially-oriented polyethylene terephthalate (i.e., Mylar) sheets and put into a mold with size of 100 millimeters (“mm”)×200 mm×2 mm. The mold was placed in a KT-201-A hot press machine from Shanghai Great Instrument Co. Ltd and preheated at 170° C. for 10 minutes. The mold was vented 8 times. Then the mold was held at 170° C. and 10 MPa as measured by the hot press machine for another 5 minutes. Next the mold was cooled to room temperature using internal water cooling within 5 minutes at 10 MPa to form plaques. The plaques were cut into 5A dogbones according to ISO 527-2.

UV-Aged samples: as used herein, UV-Aged samples are prepared by subjecting the 5A dogbones to a UV-Aging protocol. The UV-Aging protocol consists of placing the 5A dogbones selected for accelerated UV-Aging in a QUV accelerated weathering tester from Q-Lab with SOLAR EYE™ irradiance control and water spray used for accelerated UV aging following standard of ASTM D1248-16. The aging conditions are an irradiance of 0.70 W/(m²·nm) at 340 nm using with UVA-340 fluorescent lamps and cycles of 20 hours of light with uninsulated black panel temperature maintained at 70±3° C. and 4 hours of darkness condensation at 55±3° C. The UV-Aging was carried out for 2000 hours, including dark condensation periods.

Heat-Aged samples: Heat-Aged samples were produced by placing five dogbones from each example into an oven at 100° C. for 240 hours according to GB/T2951.12-2008.

### Test Methods

Nuclear Magnetic Resonance: The Total Comonomer Content of the samples is determined using ¹³C Nuclear Magnetic Resonance. NMR is performed by dissolving the sample in trichloroethane-d4 (“TCE-d4”) at 120° C. to form a homogenous solution. All NMR data are acquired at 120° C. on a Bruker AVANCE™ II 400 MHz spectrometer operating at a ¹³C resonance frequency of 100.6 MHz. A 10 mm BBO probe is employed. Chemical shifts were given in ppm (parts per million) relative to TCE-d4. Zgig was used as the pulse program of ¹³C NMR with an observed pulse of 90 degrees. Recycle delay was set to 6 seconds. The sample was scanned 4000 times. The comonomer content of the individual ethylene-based polymers is determined according to the same procedure described above.

### Results

Table 1 provides the composition of comparative examples (“CE”) 1-3 and inventive examples (“IE”) 1-9. Table 2 provides the Unaged, Heat-Aged and UV-Aged mechanical properties such as maximum tensile strength (“TS Max”), the tensile elongation at break (“TE”), max tensile strength retention (“TS Retention”) and tensile elongation at break retention (“TE Retention”) for CE1-CE3 and IE1-IE9.

TABLE 1

| Material | CE1 | CE2 | CE3 | IE1 | IE2 | IE3 | IE4 | IE5 | IE6 | IE7 | IE8 | IE9 |
|---|---|---|---|---|---|---|---|---|---|---|---|---|
| HDPE1 (wt %) | 0 | 0 | 0 | 83.98 | 0 | 83.98 | 0 | 0 | 61.37 | 62.98 | 50.00 | 48.98 |
| LLDPE1 (wt %) | 15.00 | 0 | 37.61 | 15.00 | 0 | 0 | 48.98 | 0 | 37.61 | 0 | 48.98 | 0 |
| HDPE2 (wt %) | 83.98 | 83.98 | 61.37 | 0 | 61.37 | 0 | 50.00 | 50.00 | 0 | 0 | 0 | 0 |
| LLDPE2 (wt %) | 0 | 15.00 | 0 | 0 | 37.61 | 15.00 | 0 | 48.98 | 0 | 36.00 | 0 | 50.00 |
| AO (wt %) | 0.2 | 0.2 | 0.2 | 0.2 | 0.2 | 0.2 | 0.2 | 0.2 | 0.2 | 0.2 | 0.2 | 0.2 |
| UVA (wt %) | 0.2 | 0.2 | 0.2 | 0.2 | 0.2 | 0.2 | 0.2 | 0.2 | 0.2 | 0.2 | 0.2 | 0.2 |
| HALS (wt %) | 0.6 | 0.6 | 0.6 | 0.6 | 0.6 | 0.6 | 0.6 | 0.6 | 0.6 | 0.6 | 0.6 | 0.6 |
| PA (wt %) | 0.02 | 0.02 | 0.02 | 0.02 | 0.02 | 0.02 | 0.02 | 0.02 | 0.02 | 0.02 | 0.02 | 0.02 |
| Total (wt %) | 100.00 | 100.00 | 100.00 | 100 | 100.00 | 100.00 | 100.00 | 100.00 | 100.00 | 100.00 | 100.00 | 100.00 |
| Total Comonomer | 1.13 | 1.24 | 2.82 | 3.04 | 3.11 | 3.16 | 3.67 | 4.05 | 4.22 | 4.41 | 4.81 | 5.25 |
| Content (wt %) | | | | | | | | | | | | |
| Density (g/cc) | 0.956 | 0.955 | 0.948 | 0.944 | 0.945 | 0.942 | 0.944 | 0.940 | 0.939 | 0.937 | 0.937 | 0.933 |

TABLE 2

| | | | | | | | | | | | |
|---|---|---|---|---|---|---|---|---|---|---|---|
| CE1 | CE2 | CE3 | IE1 | IE2 | IE3 | IE4 | IE5 | IE6 | IE7 | IE8 | IE9 |

Unaged Mechanical Properties

| | | | | | | | | | | | | |
|---|---|---|---|---|---|---|---|---|---|---|---|---|
| Tensile strength (MPa) | 28.2 | 27.0 | 24.7 | 21.8 | 29.7 | 30.3 | 24.8 | 30.4 | 25.6 | 31.1 | 23.9 | 29.6 |
| Tensile elongation (%) | 1000.6 | 904.8 | 1060.3 | 659.0 | 840.6 | 862.4 | 1061.8 | 817.6 | 920.5 | 828.4 | 898.7 | 758.3 |

Heat-Aged Mechanical Properties

| | | | | | | | | | | | | |
|---|---|---|---|---|---|---|---|---|---|---|---|---|
| Tensile strength (MPa) | 28.2 | 28.9 | 24.8 | 22.5 | 26.8 | 26.4 | 20.9 | 27.8 | 19.5 | 25.6 | 19.7 | 26.0 |
| Tensile elongation (%) | 346.8 | 501.5 | 622.3 | 633.4 | 901.9 | 868.3 | 845.3 | 843.6 | 791.5 | 798.5 | 807.1 | 757.3 |
| TS retention (%) | 100.0 | 107.0 | 100.7 | 103.1 | 90.3 | 87.1 | 84.6 | 91.5 | 76.3 | 82.3 | 82.4 | 87.8 |
| TE retention (%) | 34.7 | 55.4 | 58.7 | 96.1 | 107.3 | 100.7 | 79.6 | 103.2 | 86.0 | 96.4 | 89.8 | 99.9 |

UV-Aged Mechanical Properties

| | | | | | | | | | | | | |
|---|---|---|---|---|---|---|---|---|---|---|---|---|
| Tensile strength (MPa) | 27.2 | 26.5 | 21.6 | 21.0 | 25.5 | 20.9 | 19.6 | 26.3 | 18.3 | 24.7 | 17.8 | 26.5 |
| Tensile elongation (%) | 205.5 | 285.9 | 802.5 | 704.5 | 879.9 | 696.1 | 803.5 | 826.7 | 815.2 | 802.3 | 710.8 | 778.5 |
| TS retention (%) | 96.2 | 98.2 | 87.7 | 96.5 | 86.0 | 69.1 | 79.4 | 86.5 | 71.3 | 79.3 | 74.4 | 89.5 |
| TE retention (%) | 20.5 | 31.6 | 75.7 | 106.9 | 104.7 | 80.7 | 75.7 | 101.1 | 88.6 | 96.8 | 79.1 | 102.7 |

With respect to Tables 1 and 2, it can be seen that increasing Total Comonomer Content of the examples generally increases the UV-Aged and Heat-Aged tensile elongation at break and tensile elongation retention up until the Total Comonomer Content reaches 2.9 wt %. After a Total Comonomer Content of 2.9 wt % is reached, the samples exhibit a 75% retained tensile elongation at break or greater as well as 600% tensile elongation or greater at break indicating that the samples are likely to pass the more stringent standards set by ASTM D1248-16 and IEC 60811-401-2017 that apply to cable jacketing. As explained above, it is surprising that the UV-Aged and Heat-Aged mechanical properties of the polymeric composition exhibit dependence on the Total Comonomer Content and that a critical value of 2.9 wt % and greater Total Comonomer Content is able to exhibit the desired properties. Further surprising is that IE1-IE9 all have a density of 0.930 g/cc or greater yet exhibit greater retention of mechanical properties in the UV-Aged and Heat-Aged states than CE1-CE3.

1. A polymeric composition, comprising:
a first ethylene-based polymer having a density of 0.941 g/cc to 0.970 g/cc as measured according to ASTM D792;
a second ethylene-based polymer having a density of 0.860 g/cc to 0.930 g/cc as measured according to ASTM D792; and
an additive selected from the group consisting of an antioxidant, a hindered amine light stabilizer and combinations thereof,
wherein polymeric composition has a Total Comonomer Content of 2.9 wt % or greater based on a total weight of the polymeric composition.

2. The polymeric composition of claim 1, wherein the polymeric composition comprises 40 wt % to 95 wt % of the first ethylene-based polymer based on the total weight of the polymeric composition.

3. The polymeric composition of claim 2, wherein the polymeric composition comprises 5 wt % to 60 wt % of the second ethylene-based polymer based on the total weight of the polymeric composition.

4. The polymeric composition of claim 3, wherein the polymeric composition is free of carbon black.

5. The polymeric composition of claim 1, wherein the polymeric composition has a density of 0.945 g/cc or less as measured according to ASTM D792.

6. The polymeric composition of claim 5, wherein the polymeric composition exhibits a tensile elongation at break of 600% or greater in a UV-Aged state as measured according to ASTM D638.

7. The polymeric composition of claim 1, wherein the polymeric composition has a density of 0.930 g/cc to 0.945 g/cc as measured according to ASTM D792.

8. The polymeric composition of claim 7, wherein a density of the second ethylene-based polymer is from 0.918 g/cc to 0.930 g/cc as measured according to ASTM D792.

9. The polymeric composition of claim 8, wherein the polymeric composition exhibits a tensile elongation at break of 600% or greater as measured according to ASTM D638 after aging for 240 hours at 100° C.

10. A coated conductor, comprising:
a conductor; and
the polymeric composition of claim 1 disposed around the conductor.
